(19) United States
(12) Patent Application Publication
(10) Pub. No.: US 2005/0238774 A1
(43) Pub. Date: Oct. 27, 2005

(54) Cotton candy machine

(75) Inventor: Ronald R. Weiss, Okeana, OH (US)

Correspondence Address: WOOD, HERRON & EVANS, LLP, 2700 CAREW TOWER, 441 VINE STREET, CINCINNATI, OH, 45202, US

(73) Assignee: Gold Medal Products Co., Cincinnati, OH (US)

(21) Appl. No.: 10/831,015

(22) Filed: Apr. 22, 2004

(51) Int. Cl. A23B 4/03

(52) U.S. Cl. 426/517

(57) ABSTRACT

An apparatus for making cotton candy comprises a supply of sugar and a heating device for melting the sugar into a molten form. A pumping device pumps the molten sugar to an extrusion device having at least one extrusion orifice. The extrusion device is operable to extrude a strand of molten sugar from the orifice which is solidified to form cotton candy.

### FIELD OF THE INVENTION

This invention relates generally to cotton candy machines and more particularly to an improved apparatus for making cotton candy.

### BACKGROUND OF THE INVENTION

Machines for turning granular sugar into sugar filaments or “cotton candy” are generally known and have been employed for some time in concessions for traditional events such as carnivals, fairs, circuses, and sporting events. A typical cotton candy machine is operable to heat sugar granules into molten sugar and to then cast or spin the molten sugar into fibers or strands using centrifugal force. The candy fibers or strands are then directed into a tub where they are finally gathered together in a wad on a stick or rolled paper tube for service and consumption. The sugar is usually colored to impart a color to the finished cotton candy, such as pink, blue or some other color.

In order to carry out the heating and spinning functions, a typical cotton candy machine usually includes a base which houses a motor to drive a rotatable shaft. A spinner head is mounted to rotate with the shaft. The spinner head defines a chamber for receiving raw sugar. The spinner head also includes heating elements which melt the raw sugar granules into a molten sugar form. Annular slots or other openings are usually formed in the spinner head, surrounding the head. Rotation of the spinner head then imparts a centrifugal force to the molten raw sugar, and the centrifugal force causes the molten sugar to be spun or slung out of the slots in the spinner head and onto the inner surface of a bowl or basket. The basket is mounted on the base to essentially surround the spinner head. The sugar candy filaments which adhere to the basket are then transferred to a paper tube or the like. An operator will usually roll an end of the paper tube about the circumference of the basket to collect the cotton candy into a large fluffy wad on the tube end. The finished product is then sold directly to a customer right after it is made and generally at the location of the cotton candy machine. Such typical cotton candy machines are described in more detail in U.S. Pat. Nos. 3,036,532; 5,145,687; 5,441,754; 5,498,144 and 4,872,821, expressly incorporated herein by reference in their entirities for background detail.

While such cotton candy machines have been utilized successfully in the past, the market for cotton candy is changing. Traditionally, such machines were meant to be individually manned during production at the point of sale, such as at a fair or circus, for producing cotton candy for individual purchasers at that point of sale. In fact, such cotton candy production would generally occur only shortly before the purchase of the product or contemporaneously therewith, and the cotton candy fresh from the bowl or basket would be handed directly to a customer. Furthermore, one serving (or at most two servings) is generally made at a time for waiting customers. As such, the cotton candy making process has traditionally been somewhat labor intensive, time-consuming and inefficient. While existing machines and processes have traditionally been suitable for event concessions, changing sales conditions and demands in the market for cotton candy are not met sufficiently by existing machines.

For example, lately, it has become desirable to pre-make cotton candy for upcoming events so that it may be sold like any other concession, rather than being made to order at the point of sale or at the event. Furthermore, it has become desirable to market cotton candy in other non-traditional venues, such as in supermarkets and convenient stores. Generally, such cotton candy is pre-made and pre-packaged, such as in a clear plastic bag, for resale. Conventional cotton candy making machines and methods do not lend themselves to mass production of cotton candy for sale at a location removed from the machine and at a time removed from the production of the cotton candy.

Existing cotton candy machines are generally not suitable for such mass production of cotton candy, because they are labor intensive and inefficient. This makes them expensive from a mass production aspect. Furthermore, conventional cotton candy making methods include pulling an end of a paper tube around the cotton candy basket to collect the cotton candy. The cotton candy would then be handed directly to a customer. Cotton candy on a paper tube is generally not suitable for resale in other locations, and therefore the candy may have to be removed from the tube or other apparatus used to make it and placed in another package, such as a clear plastic bag. As may be appreciated, because of the fragile nature of the cotton candy, handling and further packaging of the cotton candy for such non-traditional sales venues presents various difficulties. If handled too extensively after it is made, such as to further package it, the wad of cotton candy will not be as fluffy as desired. As may be appreciated, cotton candy is made of fragile sugar filaments and extensive handling before a sale is undesired.

Accordingly, it has been one objective of this invention to address problems associated with the growing non-traditional sales and packaging of cotton candy.

A further objective of the invention has been to provide an efficient and cost effective method for making cotton candy.

To that end, it is another objective of the invention to reduce the labor intensity of cotton candy making and to increase the rate of production.

A further objective of the invention is to limit the handling of the fragile cotton candy product when it is further packaged for resale.

These objectives and other objectives are addressed by the invention set forth hereinbelow.

### SUMMARY OF THE INVENTION

An apparatus in accordance with the principles of the present invention comprises a supply of sugar, such as a hopper of granular sugar, a heating device which melts the sugar into a molten form and a pumping device which pumps the molten sugar to an extrusion device. The extrusion device has at least one extrusion orifice and the pumping device is operably coupled to pump the molten sugar into the extrusion device. The extrusion device is operable to extrude a strand of molten sugar from the orifice which is solidified to form cotton candy. That is, the cotton candy is not formed by slinging sugar using centrifugal force, rather it is extruded.

In accordance with one embodiment of the invention, a hopper of granular sugar is coupled to a screw extruder which delivers the sugar to the pumping device. A heater may be coupled with the hopper or extruder such that the sugar is heated and melted prior to delivery to the pumping device. One suitable pumping device is a geared metering pump which is operably coupled to the screw extruder for pumping the molten sugar to the extrusion device.

In accordance with one embodiment of the invention, the extrusion device is a spinnerette having a head with multiple orifices. The spinnerette is operable for simultaneously extruding multiple strands of sugar for forming the cotton candy. In another embodiment of the invention, the extrusion device comprises a plurality of nozzles which are also operable for simultaneously extruding multiple strands of sugar and forming the cotton candy. Preferably, the extrusion device, whether a spinnerette or plurality of nozzles, is movable in multiple directions, either lineally or rotationally, for directing the extruded strands of sugar in multiple directions to form a fluffy wad of cotton candy, which is the desirable form of such candy.

Therefore, the present invention is significantly different from conventional cotton candy machines which utilize centrifical force to create strands of sugar around a bowl. The present invention is more suitable for mass production of cotton candy to be pre-made and resold at a subsequent time and at a different location than when and where it is made. The invention is not as labor intensive as conventional cotton candy machines, and therefore is more efficient and cost effective. Furthermore, the invention reduces handling of the fragile cotton candy product.

The multiple strands of molten sugar extruded from the extrusion device are solidified to form the finished cotton candy product. To assist such solidification, and in accordance with another aspect of the present invention, multiple strands may be directed into a cooling chamber, such as a refrigerated cooling chamber coupled to a source of coolant or refrigerant. The cooling chamber assists in the rapid solidification of the cotton candy to form the desired fluffy and high volume finished product. Alternatively, a source of cool air may be directed to impinge upon the extruded strand to further solidify the strand to form the cotton candy. In still another embodiment, both the cooling chamber and streams of cooling air may be utilized to assist the solidification process.

In accordance with another aspect of the present invention, a conveyor device is utilized and is operable for conveying a package proximate to the extrusion device for capturing the strands of sugar and containing the wad of cotton candy. The conveyor device, which may include a conveyor belt, is further operable for conveying the package full of cotton candy away from the extrusion device for further processing and for conveying a new empty package to the extrusion device for forming cotton candy therein. That is, the cotton candy is made directly in the package in which it will be sold.

Utilizing the present invention, large amounts of cotton candy can be manufactured with fewer laborers. Furthermore, the inventive process for making the cotton candy allows it to be quickly packaged and processed without unnecessary handling which may undesirably reduce the fluffiness and overall volume of the cotton candy product. Therefore, cotton candy can be produced efficiently and cost effectively with less labor and an increased rate of production. These advantages and other advantages and features of the invention will become more readily apparent from the detailed description of the invention below.

### BRIEF DESCRIPTION OF THE DRAWINGS

The accompanying drawings, which are incorporated in and constitute a part of this specification, illustrate embodiments of the invention and, together with a general description of the invention given below, serve to explain the principles of the invention.

FIG. 1 illustrates a schematic view of a system for making cotton candy in accordance with the principles of the present invention.

FIG. 2 is a perspective view of a spinnerette utilized in the invention.

FIG. 3 is a side view of a bank of nozzles utilized in an alternative embodiment of the present invention.

### DETAILED DESCRIPTION OF THE INVENTION

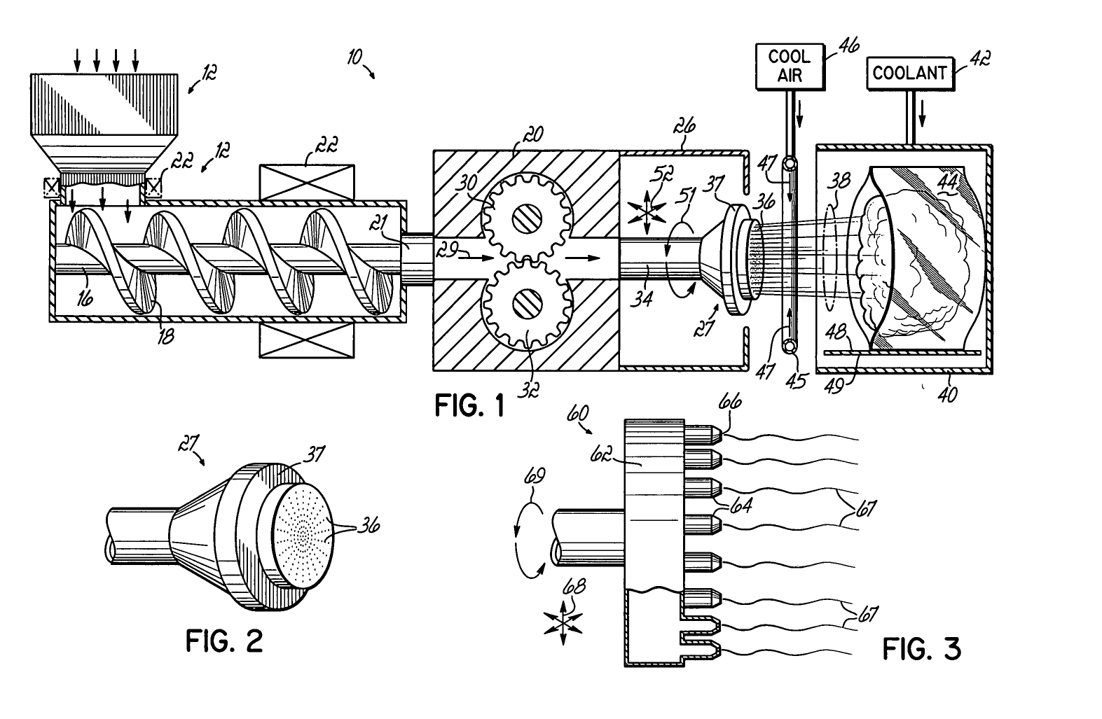

FIG. 1 illustrates a diagrammatical view of an inventive cotton candy making system in accordance with the principles of the present invention. Specifically, System (10) comprises a supply (12) of sugar for making the cotton candy. Generally, the sugar of supply (12) will be in a common granular form, which is then melted into a molten form for making the cotton candy strands. The sugar is often colored with an edible coloring so that the cotton candy is colored as well. The sugar may be colored in granular form, or coloring may be added to the molten sugar.

Sugar supply (12) is coupled to a suitable delivery or conveying device (14) to move the sugar from the supply (12). Supply (12) might be a hopper which is gravity fed into the delivery device (14). One suitable delivery device (14) illustrated in FIG. 1 is a screw extruder which utilizes a rotating screw shaft (16) with threads (18) which deliver or drive the sugar to a pumping device (20). A heater (22) may be coupled to a portion of supply (12) or may be coupled to the delivery device (14) as shown in FIG. 1. Heater (22) is operable to heat the granules of sugar into a molten form so that the molten sugar may be utilized to form the cotton candy strands as discussed further hereinbelow. The delivery device (14) is coupled to pumping device (20) through an appropriate coupling connection (21). Thereby, the molten sugar is delivered to the pumping device (20).

Pumping device (20) may be any suitable pump which is operable to pump molten sugar to an extrusion device (26), such as a spinnerette (27) as shown, for forming the sugar into fibers and strands to form the cotton candy wad. The pumping device (20) illustrated in FIG. 1 is a geared metering pump which creates a suction force, indicated by reference arrow (29), on the left or inlet side of the pump and a higher pressure discharge force, as indicated by reference arrow (28), on the outlet or right side of the pump. A geared metering pump utilizes two opposing gears (30), (32) which cooperate to drive the molten sugar through the pump at a suitably high pressure for introduction to the extrusion device (26). Screw extruders and geared metering pumps are commercially available and may be utilized in the system (10) in accordance with the principles of the present invention.

To form the strands and fibers of the cotton candy, the molten sugar is extruded at a high pressure through extrusion device (26). The extrusion device has at least one orifice or hole (36), and when molten sugar is pumped to the extrusion device, it is operable to extrude a strand of the molten sugar from the orifice. The strand of molten sugar is solidified to form the cotton candy. To that end, pump (20) is appropriately coupled to the input end (34) of the extrusion device. One embodiment of the invention, as illustrated in FIG. 1, utilizes an extrusion device comprising a spinnerette (27). The output end, or head (37) of the spinnerette (27) comprises a large number of small holes (26) through which the molten sugar is extruded. The holes (36) in the spinnerette head (37) have a sufficient cross-sectional dimension, such as a diameter, and a sufficient length, to form the molten sugar into filaments (38) or strands when the sugar is pumped therethrough at a suitable pressure. Filaments (38) emerge from the holes (36) and are solidified for forming the wad of cotton candy. The spinnerette extrudes multiple strands (38) simultaneously. Generally, the solidification will occur due to the temperature change from inside the spinnerette (27) to the outside atmosphere surrounding the head (37) of the spinnerette. In one embodiment of the invention, two or three hundred holes might be utilized in the spinnerette head (37) having a diameter from 7 to 8 mils, for example. Of course, the number of holes and their dimensions may be varied as desired.

The cotton candy strands (38) are extruded and solidified as endless filaments in a technique referred to as spinning. The molten strands formed from spinning are solidified by cooling. The individual strands combine to form a wad of cotton candy. In accordance with one aspect of the present invention, a cooling chamber (40) might be utilized and may be connected to a supply of coolant liquid (42), such as a refrigerant, for creating a cool atmosphere in the chamber (40) into which the strands (38) are directed. A package or container (44), such as a clear plastic bag or other container, might be positioned within the cooling chamber (40) to receive the sugar strands (38) and contain the finished cotton candy product. Alternatively, or possibly in addition to the cooling chamber (40), cool air (46) might be directed as shown by reference arrows (47) to intercept the strands (38) and thereby assist in their cooling and solidification. For example, the extruded cotton candy strands might be directed through an air ring. Once a sufficient amount of cotton candy has been formed in the container (44), the filled container (44) can then be moved away so an empty container may then be subsequently filled. A conveyor device (49), such as one including a conveyor belt (48), might be utilized in conjunction with the cooling apparatuses for conveying a container (44) to the extrusion device (26) to be filled with cotton candy and then for directing the finished containers or packages of cotton candy to another location for further processing and shipment.

In accordance with another aspect of the present invention, spinnerette (27) may be utilized with an extrusion device (26) which incorporates mechanical structures (not shown) for moving the spinnerette. That is, spinnerette (27) may be part of a larger machine (26) which is operable for moving the spinnerette head rotationally or linearly as indicated by the reference arrows (51), (52). The movable spinnerette (27) will allow the cotton candy to be spun around inside the package (44) so that the entire package might be filled in a suitable fashion. The extruded strands of sugar are directed in multiple directions to form the wad of cotton candy. Moving the spinnerette (27) toward and away from the package and in various directions as noted assists in forming a fluffy and high volume finished product that will be attractive to a consumer.

Alternatively, the container (44) may be moved, such as by the conveyor device (49) while the spinnerette (27) is stationary. However, moving the container (44) in multiple linear or rotational directions may be more complicated than simply moving the spinnerette (27).

FIG. 3 illustrates an alternative embodiment of the present invention, wherein a plurality or bank of nozzles is utilized as an extrusion device rather than a spinnerette (26). That is, the bank of nozzles (60) is coupled to pumping device (20) for extruding individual strands of molten sugar into a cotton candy form. The bank of nozzles (60) may comprise an elongated body portion (62) which is coupled to individual nozzles (64). Each of the nozzles has one or more orifices (66) for extruding the cotton candy strands (67). The bank of nozzles (60) may also be moved in various different linear directions or rotated as indicated respectively by reference arrows (68) and (69) to form a fluffy, high volume wad of cotton candy. As illustrated in FIG. 1, when the bank of nozzles (60) is utilized, the cotton candy may be directed through a cooling air stream (47) or into a cool chamber (40) for solidifying the strands (67).

The present invention lends itself to an assembly line or mass production of cotton candy for resale at locations removed from the manufacturing facility and also at a time significantly after the cotton candy is manufactured, as compared to traditional point of sale methods. The inventive apparatus and method present a more efficient and cost effective way for making cotton candy which reduces the labor requirements and increases the rate of production. Furthermore, the handling of the finished cotton candy product, such as by human workers, is limited, which then not only keeps the cotton candy in a fluffy form, but also will limit the chances for contamination of the product. The present invention addresses the resale of cotton candy in supermarkets and convenient stores, which channel of trade is becoming ever more popular.

While the present invention has been illustrated by the description of the embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details representative apparatus and method, and illustrative examples shown and described. Accordingly, departures may be made from such details without departure from the spirit or scope of applicant's general inventive concept.

1. An apparatus for making cotton candy comprising:
a supply of sugar;
a heating device for melting the sugar into a molten form;
a pumping device for pumping the molten sugar;
an extrusion device having at least one extrusion orifice, the pumping device operably coupled to pump the molten sugar into the extrusion device;
the extrusion device operable to extrude a strand of molten sugar from the orifice which is solidified to form cotton candy.

2. The apparatus of claim 1 wherein said extrusion device comprises a spinnerette including a plurality of orifices, the spinnerette operable for simultaneously extruding multiple strands of sugar in forming the cotton candy.

3. The apparatus of claim 1 wherein said extrusion device comprises a plurality of nozzles wherein each nozzle includes at least one orifice, the plurality of nozzles operable for simultaneously extruding multiple strands of sugar in forming the cotton candy.

4. The apparatus of claim 1 wherein said extrusion device is movable for directing the extruded strand of sugar in multiple directions to form a wad of cotton candy.

5. The apparatus of claim 1 further comprising a delivery device coupled between the supply of sugar and the pumping device for delivering the sugar to the pumping device.

6. The apparatus of claim 5 wherein said delivery device comprises a screw extruder.

7. The apparatus of claim 1 wherein said pumping device comprises a geared metering pump.

8. The apparatus of claim 1 further comprising a cooling chamber, the extrusion device operable to direct the extruded strand of sugar into the cooling chamber for solidifying the strand to form the cotton candy.

9. The apparatus of claim 1 further comprising a cooling device for directing a stream of cooling air at the extruded strand of sugar for solidifying the strand to form the cotton candy.

10. The apparatus of claim 1 further comprising a conveyor device operable for conveying a container proximate to the extrusion device for capturing the strand of sugar and containing the cotton candy, the conveyor device further operable for conveying the container of cotton candy away from the orifice for further processing.

11. A method of making cotton candy comprising:
melting an amount of sugar into a molten form;
pumping the molten sugar into an extrusion device having at least one extrusion orifice;
forming a strand of molten sugar with the extrusion device and extruding the strand through the orifice;
solidifying the molten strand of sugar;
directing the strand to form a wad of cotton candy.

12. The method of claim 11 further comprising pumping the molten sugar into a spinnerette including a plurality of orifices, the spinnerette operable for simultaneously extruding multiple strands of sugar in forming the cotton candy.

13. The method of claim 11 further comprising pumping the molten sugar into a plurality of nozzles where each nozzle includes an orifice, the nozzles operable for simultaneously extruding multiple strands of sugar in forming the cotton candy.

14. The method of claim 11 wherein said extrusion device is movable, the method further comprising moving the extrusion device in multiple directions for directing the extruded strand of sugar in multiple directions to form a wad of cotton candy.

15. The method of claim 11 further comprising delivering the sugar to the pump with a conveying device comprising a screw extruder.

16. The method of claim 15 further comprising feeding solid sugar into the screw extruder and melting the sugar as it is conveyed to the pump.

17. The method of claim 11 further comprising pumping the molten sugar with a geared metering pump.

18. The method of claim 11 further comprising directing the extruded strands of sugar into a cooling chamber for solidifying the strand for forming the cotton candy.

19. The method of claim 11 further comprising directing a stream of cooling air at the extruded strand of sugar for solidifying the strand for forming the cotton candy.
